(19) United States
(12) Patent Application Publication
(10) Pub. No.: US 2008/0243955 A1
(43) Pub. Date: Oct. 2, 2008

(54) Bit Stream Backup Incorporating Parallel Processes

(75) Inventors: Michael Robert Anderson, West Linn, OR (US); Kim B. Schaffer, Falls Church, VA (US)

Correspondence Address: MICHAEL O. SCHEINBERG, P.O. BOX 164140, AUSTIN, TX, 78716-4140, US

(73) Assignee: New Technologies Armor, Inc., Jacksonville, FL (US)

(21) Appl. No.: 11/792,649

(22) PCT Filed: Dec. 9, 2005
(86) PCT No.: PCT/US05/44875

§ 371 Date: Jan. 7, 2008

Related U.S. Application Data
(60) Provisional application No. 60/634,678, filed on Dec. 9, 2004.

(30) Foreign Application Priority Data
Dec. 8, 2005 (US) 11/297649

(51) Int. Cl. G06F 17/30

(52) U.S. Cl. 707/204; 707/E17.01

(57) ABSTRACT

Forensic analysis of computer data is facilitated by analyzing data as it is being read from a target storage (10), rather than from a restored bit stream back-up file. In some embodiments, multiple processors (16) or threads run different analyses simultaneously. In some embodiments, the analyses are performed on very small amounts of data, with additional data being read when necessary to determine whether the first data meets the analysis criteria.

This application claims priority from U.S. Provisional Pat. App. No. 60/634,678, filed Dec. 9, 2004, which is hereby incorporated by reference.

### TECHNICAL FIELD OF THE INVENTION

The present invention relates to computer forensic analysis tools.

### BACKGROUND OF THE INVENTION

When a typical computer user backs up the data of his hard disk drive, he copies the files on the hard disk drive to a drive on another computer or to a removable storage medium. When a forensic investigator requires a copy of a computer drive, a common backup is not sufficient. Normal copying of a file may change file management information of the target hard disk. Also, much of the data contained on a computer hard disk drive is unknown to the computer user whose work session created the data, and such data is not copied in a normal file back-up. This incidental data has the potential of providing useful information for investigators, internal auditors, and others who have an interest in computer evidence. Such incidental data, which exists on a storage media as an artifact of the system, rather than by any intent of the user, is referred to as “ambient data.” The information in the ambient data may provide a truer picture of the computer use than the information of which the user is aware and can easily modify. The investigator can also use leads gleaned from ambient data to search the data in regular computer files, that is, in allocated file space. “Ambient data” is used herein to include any data that is not ordinarily accessible to a typical computer user, and can include data that is contained in previously erased files, unused space at the end of the block of space allocated to a file, data in temporarily files, such as the swap files used by Windows to manage memory, and disk management data, such as any file allocation tables or other data that describes the data on the medium.

The computer from which the data is derived is referred to as the “target computer” and the storage medium is referred to as the “target storage medium,” “target disk” or “target device.” Rather than copying files, a forensic investigator will typically make a “mirror image” of the entire target medium, typically a hard disk or a partition of the hard disk. Such a mirror image is called a “bit stream backup” because the hard disk or other storage device is copied bit by bit onto the backup medium, without regard to the file structure. A bit stream back-up is also referred to as an “evidence grade” backup. After the bit stream backup of a target storage device is created, the backup is used to recreate the contents of the storage medium onto a working storage medium for analysis. The original bit stream backup is typically maintained as evidence.

SafeBack® is an industry standard bit stream backup program available from NTI-Armor, Inc. SafeBack can be used to preserve computer related evidence when criminal and civil litigation is involved. SafeBack technology is also currently used by military agencies to capture data images of computer hard drives in intelligence gathering missions and War-On-Terror-related matters.

To make an evidence grade bit stream backup, the target medium is preferably removed from the target computer and connected to another computer. It is desirable to avoid using the target medium to boot the target computer and operate the backup software, because such actions may alter the contents of the target medium, particularly the file management information and the ambient data.

If the environment of the investigation is such that it is desirable to create the bit stream backup without removing the target medium from target computer, the backup is preferably performed without the target computer loading the Windows operating system from the target medium. For example, the target computer may be started or “booted” into DOS, Linux, or other disk operating system, from a floppy diskette, a CD, or a USB device, such as a flash drive, a floppy drive, or a hard disk drive. The method of booting the computer will depend on the configuration of the computer and the basic input-output system (BIOS) used by the computer. Skilled persons can determine an appropriate process for a computer. The backup software, such as SafeBack, is also preferably not run from the target drive, but is run from the floppy disk drive, CD, or the USB device. By operating the backup program in a DOS or Linux environment, there are minimal changes to the target drive.

Safeback first reads contiguous sectors of data from the target data storage device, typically a hard disk drive, beginning with the first sector of the targeted storage device. The targeted storage device is typically either a logical partition of a computer hard disk drive or all of the data storage areas on the targeted physical hard disk drive. The extent of the backup is determined by the investigator. In most cases, the backup data includes system information, system swap or page files, allocated files, unallocated storage space and file slack. In the case of a physical hard disk drive backup, the data also includes data storage areas that exist outside of partitions. SafeBack routinely captures allocated file space and ambient data, making no distinction between allocated files and ambient data areas. The software reads all data at a sector level and ignores cluster assignments, file names, file sizes, etc.

During the backup process, SafeBack stores the data in memory buffers. While the data is in memory buffer, the software performs a mathematical operation, referred to as a “hash” to produce a check value characteristic of a subset of the data. One such hash is a cyclical redundancy check (CRC) algorithm. Safeback writes both the data and calculated CRC value to disk. At the option of the software operator, the data can be written to disk in raw form or in encrypted form. The CRC value can be used to verify the integrity of the data. When the data is later read from the back-up file, another CRC value is calculated. If the new CRC value does not match the value originally stored with the data, the data has been corrupted.

The SafeBack output is stored in the form of a file which can be used to restore the image of the targeted hard disk drive to a working medium for evidence processing. This file is known as a SafeBack file and the restoration process essentially involves the reverse process whereby the restored data is written to a hard disk drive of equal or larger size than the original targeted hard disk drive. The resulting restored drive is essentially identical to the original, with the possible exception of the first sector which is the Master Boot Record on a Microsoft-based hard drive. The CRC value provides assurance that the backup file is accurate, and has not been corrupted or tampered with.

After the backup is restored to a working drive, commercially available computer forensics products can be used to process and interact with the restored bit stream backup image. The extent of the computer forensic analysis is determined by a computer forensics analyst and, may involve, for example:

A. Viewing the stored data in either its raw or allocated form.

B. Searching the data using predefined search terms which, may consist of partial words, words or multiple words. These search terms are typically stored in a file in ASCII text form and they are specific to the investigation that necessitated the creation of the bit stream backup.

C. Cataloging the data based on names of allocated and deleted files, file times, file dates, file attributes and file sizes.

D. Identifying specific file types based upon file headers and reconstructing those files for review and analysis based upon the requirements of the investigation involved, e.g., Mail PST files, graphics files, swap files, page files, etc.

U.S. Pat. Nos. 6,263,349, 6,279,010, and 6,345,283 to the applicant describe various techniques for data analysis. There are several products that analyze data after the bit stream backup has been created. U.S. Pat. No. 6,792,545 to McCreight et al. describes a system for forensic investigation of a target machine on a network. The system of McCreight et al. installs a servelet on the target machine, instructs the servelet to retrieve data from the storage device, and then transmits the data from the target machine. The data is then saved for analysis on a client machine.

U.S. Pat. Pub. No. 2004/0143609 of Gardner et al. describes a system for locating information in conventional back-up files using a non-native environment, that is, a computing environment that is different from the one in which the data originated. The system of Gardner et al. can filter files before the files are written to the back up subsystem. The system is limited to checking actual user files and does not teach analyzing a forensic back-up that includes data, such as file slack and unallocated space, that is, not files.

The tools described above require a trained investigator to decide which analyses to run and then to run the analyses and evaluate the results. A major problem in the forensic analysis of computer data is the overwhelming amount of data available to be analyzed. Modern hard disks on personal computers typically have capacities in the tens or hundred of gigabytes. When there is a large quantity of data to review, the task of deciding which analyses to run on each disk image and then running each analysis can be daunting. To conserve resources, an investigator will often limit the number of analyses he decides to run. Although this saves investigator time, it can result in important evidence being overlooked.

### SUMMARY OF THE INVENTION

An object of the invention is to provide improved and more efficient forensic analysis of computer data.

In accordance with an embodiment of the invention, computer data is analyzed while it is being copied from the target medium, rather than from a completed backup file. The invention can be used for screening a large amount of data, with a more thorough analysis being performed on back-up files based on the results of the screening. The invention allows more efficient evaluation of large amounts of computer data, and can flag to the investigator information that may be significant from the extremely large amount of information being processed.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more through understanding of the present invention, and advantages thereof, reference is now made to the following descriptions taken in conjunction with the accompanying drawings, in which:

FIG. 1 is a block diagram showing schematically the hardware relationships in an embodiment of the invention.]

FIG. 2 is a block diagram showing schematically the hardware relationships in another embodiment of the invention

FIG. 3 is a flow chart showing steps of a preferred embodiment of the invention.

FIG. 4 shows another embodiment of the invention.

FIG. 5 is a flowchart showing preferred steps for using the embodiment of FIG. 4.

### DETAILED DESCRIPTION OF PREFERRED EMBODIMENTS

Prior art computer forensic processing of hard disk drives typically involves a two step process, i.e., the creation of a bit stream backup file and the subsequent analysis of the bit stream backup file. This process can be time consuming and tedious.

Embodiments of the present invention provide a system for analyzing data, preferably both allocated file space and ambient data, while the data is being retrieved from a target medium and before it is saved into a bit stream backup file. Some embodiments provide for the concurrent creation of bit stream backup files and the analysis of the bit stream, thereby allowing computer forensics analysts to pre-process computer hard disk drives and eliminate steps in the computer forensics processes. In some embodiments, the analysis during backup can provide a screen to provide the investigator with some idea of the forensic value of the data, so that more detailed analyses can be performed, if appropriate.

Embodiments of the invention provide a method of forensic analysis that includes screening the bit stream from a target medium as the data is read from the target medium and creating output analysis files concurrently with creating a bit stream backup. Based upon the results of the screening, additional analysis can be performed on the output analysis files or on a restored image of the target medium.

In some cases, the pre-processing of computer hard disk drives will eliminate the need to perform a full forensics examination of a computer hard disk drive. In some cases, the screening analysis can provide an indication of what types of analysis are the most likely to produce useful information. This allows an investigator to use a more detailed, targeted analysis on some data, which analysis may be too time consuming to run indiscriminately on all data. Screening also reduces analysis time and can help eliminate computer evidencing backlogs world-wide in the FBI, US Military, law enforcement and foreign governments.

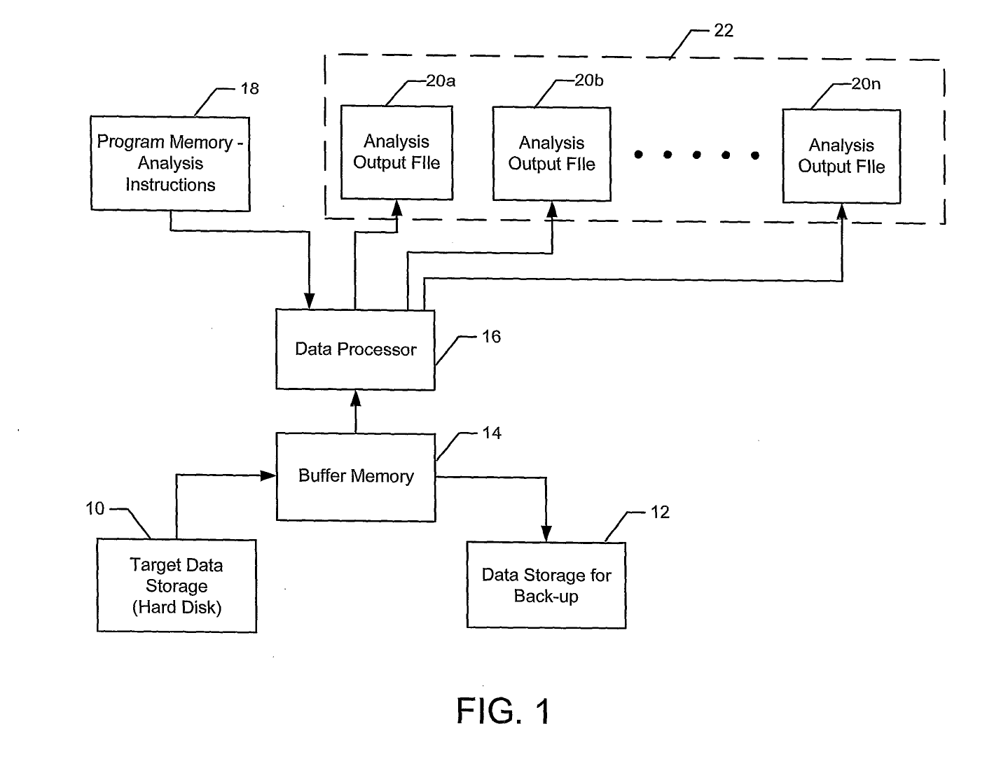

FIG. 1 is a block diagram showing the various elements involved in one preferred implementation of the invention. The preferred process transfers data from a target memory storage unit 10, such as a hard disk drive, to a data storage back-up drive 12. As the data is being copied, it is temporarily stored in a buffer memory 14. A processor 16 analyzes the data in accordance with one or more analysis techniques corresponding to program instruction stored in a program memory 18. The results of the analysis are stored in analysis output files 20a, 20b, . . . 20n in memory 22, typically using different files for different types of investigative leads. Thus, embodiments of the invention can allow for performing multiple analyses, without the investigator having to create a back-up file and then run each analysis separately on the backup file. Processor 16 can be the processor on a computer on which the target memory storage unit 10 resides, or it can be different processor.

The target drive can be accessed in various ways, similar to the ways described above with respect to backup programs. For example, the target medium can be removed from the target computer and temporarily installed in a working computer. In this case, the analyses are performed on the working computer, that is, processor 16 can be the CPU of the working computer and the analyses program instructions 18 are stored in the memory of the working computer. In some embodiments, the analyses program are run on the target computer, and the processor 16 is the processor of the target computer, while the program instructions are stored on a removable media, such as a floppy drive, CD, or USB storage, which is preferably a bootable medium, to avoid loading the Windows.

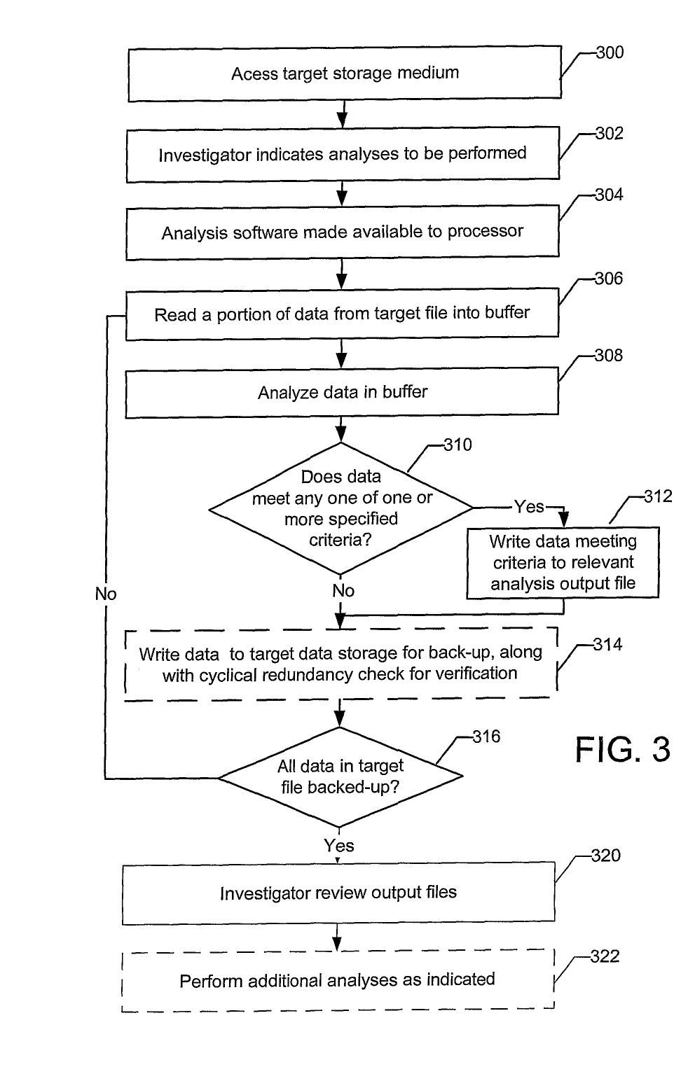

In another embodiment, shown in FIG. 2, a dedicated device 202 can be used to assist in implementing the invention. The device can include a processor 204, a program memory 206 that includes files 210 for booting the target computer and files 212 for performing analyses, a user interface 214 for accepting user instructions and displaying information, and interfaces for connecting to the target computer or target drive 220 and to an external storage 222 for saving analysis output files and a bit stream backup file. Device 202 optionally includes internal mass storage 230 for saving the analysis program output and/or the backup file. The user interface can include, for example, a liquid crystal display and a touch screen.

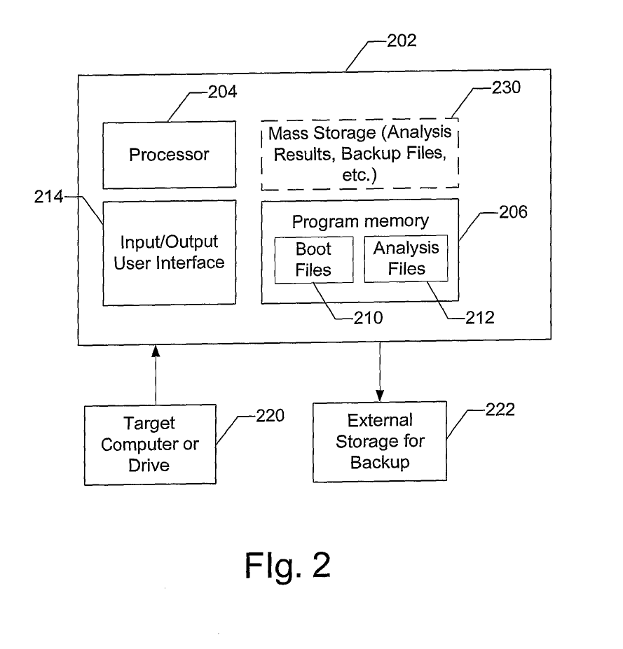

FIG. 3 shows the steps involved in a preferred method. In step 300, the target drive is accessed as described above. In step 302, the investigator specifies the analysis or analyses to be performed. In step 304, the appropriate computer instructions are made available to the processor, for example, by loading the instructions into a program memory. In step 306, data is read from a target file and temporarily stored in a buffer memory. Contiguous data in sectors is preferably read in, without regard to whether the data is in allocated memory. In step 308, the data in the buffer memory is analyzed in accordance with the program instructions. In decision step 310, the program instructions determine whether any part of the data meets analysis criteria specified by any of one or more specified analyses. If any analysis criterion is met, the data meeting the criterion is written in step 312 to a one or more output files, each file preferably containing data that meets a specific criterion or group of criteria. If data meets multiple analysis criteria, it may be stored in multiple files.

In step 314, the data in the buffer memory is written into the back-up file, along with a cyclical redundancy check (CRC) to allow later authentication of the back-up file. Step 314 maybe omitted in some embodiments. Decision block 316 shows that if there is additional data to be backed-up, the system returns to step 306. After all or the desired portion of the target file has been backed-up, the investigator can review the results of the analyses in step 320. It is not necessary that the steps be performed in the order described. For example, the data in the memory buffer can be copied to the back-up file, and then the copy remaining in the buffer analyzed. In optional step 322, the investigator performs a more thorough analysis of some aspect of the data, based on the results of the previous analysis. The investigator can use the described steps as a screening analysis to go through a large amount of data, and then perform a more detailed analysis on portions of the data shown to be of interest by the screening analysis.

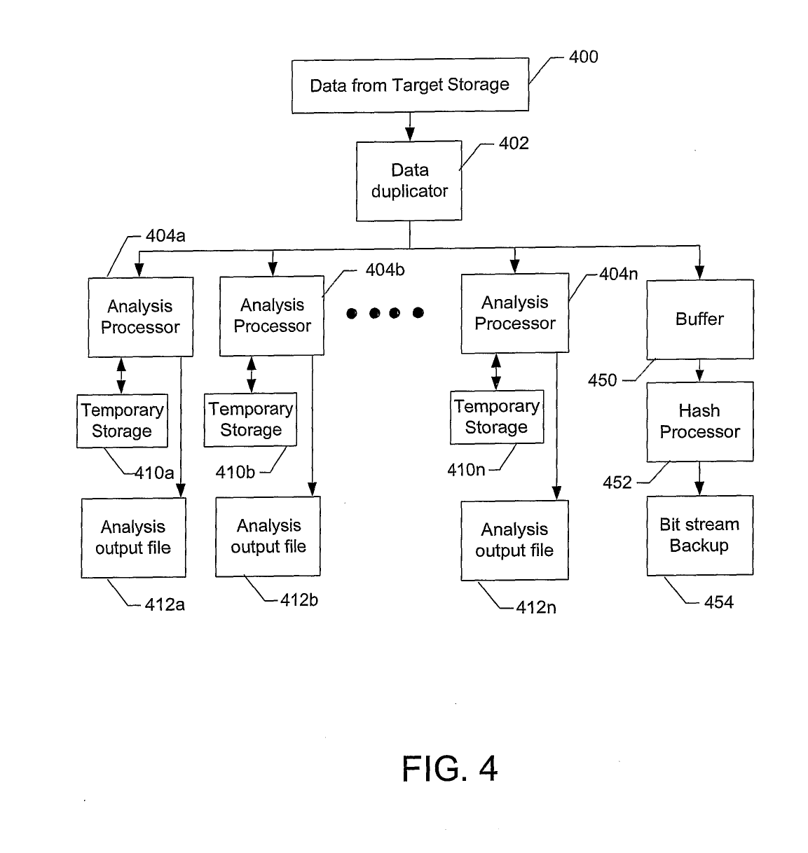

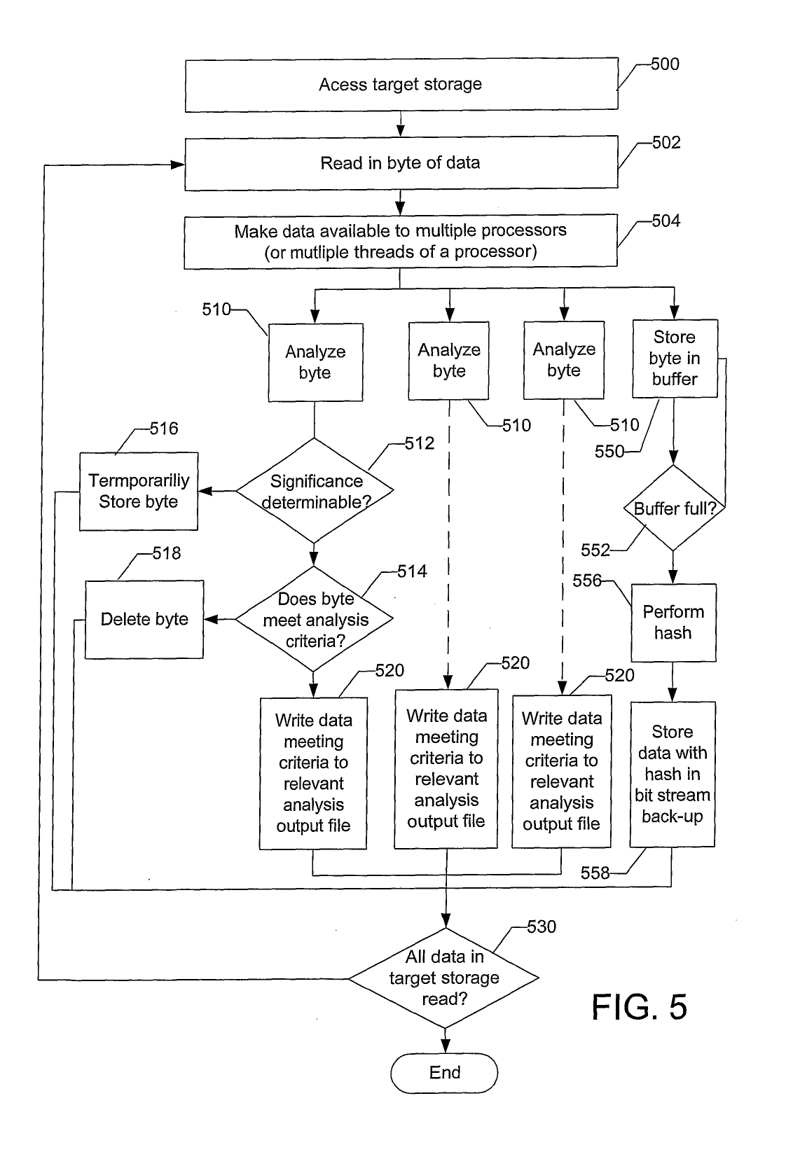

FIG. 4 shows the relationship of elements used in another embodiment, and FIG. 5 shows the preferred steps for using the elements shown in FIG. 4. In step 500, the target storage is accessed, and data is read in step 502 from the storage. FIG. 4 shows that data from target storage 400 communicates with a data duplicator 402. While this embodiment analyzes a small amount of data at a time, the computer operating system may be reading in more data or a continuous stream of data. In step 504, the incoming data is made available concurrently to multiple processors. For example, the data may be output on a separate line for each processor by data duplicator 402, which can be a buffer or driver having a single data input and multiple data outputs. Alternatively, a single set of data lines may be accessible to the inputs of each of the multiple processors.

Multiple processors 404a-404n, referred to non-specifically as processor 404, perform forensic analyses on the data streams. The processors can be, for example, microprocessors, application specific integrated circuits, or field programmable gate arrays (FPGAs). Instead of multiple processors, some embodiments could use a single processor that processes multiple threads. Examples of the types of analyses performed were described previously. Preferably, a separate data stream is directed to each processor 404, and each processor performs a separate analysis of its data stream.

The data is preferably a small number of bits, such as a byte or a word. Each of processors 404a-404n analyzes the data in step 510 in accordance with a different stored program. The analysis attempts to determine whether or not the data meets certain criteria that would indicate whether the data might be significant, that is, whether the data would be of interest to an investigator. Decision block 512 shows that in some instances, the processor may be able to determine from the byte alone whether the data is significant. In other instances, the significance of the data cannot be determined until additional data is read in. For example, the first byte read may indicate that the data corresponds to ASCII text, and the data can be temporarily saved to see whether or not the text, along with subsequent text, corresponds to an e-mail address or other information sought by the investigator.

If the significance of the data can be determined, it is determined in step 514. If the processor cannot determined the significance, in step 516 the processor 404 temporarily stores the data in temporary storage 410, waits for additional data to be read in, and then repeats the analysis. The additional data helps determine whether the previous data was significant. If the data is determined to not be significant in step 514, the data is deleted in step 518. If the data is determine to be significant, it is saved in a corresponding one of output analysis files 520a to 520n in step 520. The process is continued until all the data in the target storage has been processed. Each of the processors 404a-n is repeating steps 510 to 520 using a different analysis, as shown by the multiple instances of blocks 510 and blocks 520, and the dotted lines between them.

In some embodiments, while the analysis is being performed, a bit stream backup is also being created. As the data is read in, it is saved in a buffer 450 in step 550. Buffer 450 may hold, for example, 512 bytes. When the buffer accumulates a specified amount of data as shown in decision block 552, processor 452 performs a hash algorithm in step 556 to produce a check value, such as a CRC. In step 558, the data in the buffer is saved in a bit stream backup file 454, along with the check value.

After the analysis output files and the optional bit stream back-up file are created, the investigator can use the information in the analysis output files directly, or can use the information to determine additional analyses that may be beneficial to run.

While the example about uses a byte of data, this embodiment is not limited to any specific amount of data. In the embodiments of FIGS. 4 and 5, the processors analyze an amount of data in each step that is typically much less than the amount of data used to perform the hash algorithm for the bit stream back-up. Unlike the prior art, which loads a relatively large amount of data into a buffer, and then performs a complete analysis on the data in the buffer, the present invention analysis a much smaller amount of data at one time, and then, if necessary, reads additional data to complete the analysis of the previous data. Using less data for the analysis makes each analysis quicker, so that the entire data stream can be processed more rapidly

As described above, in some embodiments, the system concurrently analyzes the data and creates a bit stream backup file by reading contiguous sectors of data from the target data storage device beginning with the first sector of the target storage device. The target storage device can be, for example, either a logical partition of a computer hard disk drive or all of the data storage areas on the targeted physical hard disk drive. The extent of the backup is determined at the option of the operator of the software application. The backup data typically includes system information, system swap or page files, allocated files, unallocated storage space (erased files) and file slack. In the case of a physical hard disk drive backup, the data also includes data storage areas that exist outside of partitions. Most embodiments capture ambient storage data and make no distinction between allocated files and ambient data areas. The software reads all data at a sector level and it ignores cluster assignments, file names, file sizes, etc.

The preferred system analyzes the data, and creates output files in addition to bit stream back-up files. The output files can correspond to different analyses, such as those described in paragraphs A-D above, at the option of the investigator. Additional analyses that can be performed include, for example, techniques for locating:

E. Proper names of individuals stored as data in allocated files and ambient data storage areas. Proper names include first, last and or middle initials and can exist in various formats depending upon the ethnic derivation of the name involved. This technique is described in U.S. Pat. No. 6,263,349, which is hereby incorporated by reference.

F. E-Mail addresses stored as data in allocated files and ambient data storage areas (defined previously). This process is technique is described in U.S. Pat. No. 6,279,010, which is hereby incorporated by reference.

G. Internet web addresses (URLs) stored as data in allocated files and ambient data storage areas. This technique is described in U.S. Pat. No. 6,279,010.

H. A sampling of English or other language sentence structure as contained in the system swap or page files to provide the analyst with an indication of the nature of communications stored on the target computer. This technique is described in U.S. Pat. No. 6,345,283, which is hereby incorporated by reference.

Although the present invention and its advantages have been described in detail, it should be understood that various changes, substitutions and alterations can be made herein without departing from the spirit and scope of the invention as defined by the appended claims. For example, while the examples describe a target computer using the Windows operating system, the invention is not limited to any particular type of target computer or operating system, and can be used, for example, on computers running Windows, Apple or Macintosh operating systems, UNIX, Linux, or other operating systems. Connections between the various devices can be made using any connection systems, such as IDE, USB, firewire, etc. The terms “storage device” and “storage medium” are used interchangeably.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method for forensic analysis of a information stored on a computer, the method comprising:
a. reading contiguous bits of data from an original target data storage;
b. storing the contiguous bits of data in a temporary data storage memory, the stored data being a subset of the data stored on the target data storage and including bits from ambient data and from user files;
c. analyzing the data stored in the temporary memory storage in accordance with stored computer instructions to determine whether any of the data meets one or more specified investigative criteria;
d. if the data stored in the temporary memory storage meets one or more of the specified investigative criteria, writing at least a portion of the data into one or more analysis output files;
e. writing the data to a bit stream back-up file regardless of whether the data meets the specified investigative criteria;
f. repeating steps a-e until all data from the original target data storage has been analyzed;
g. using the results of the analysis in step c to determine recommended at least one additional analysis; and
h. analyzing one or more of the analysis output files or the bit stream back-up file using the analysis determined in step g.

2. The method of claim 1 in which writing the bit stream to a bit stream back-up file includes writing a check value to the back-up file.

3. The method of claim 1 in which reading a contiguous bit stream of data from an original target storage includes reading a contiguous bit stream of data from a partition of a hard disk.

4. The method of claim 1 in which analyzing the data stored in the temporary memory storage in accordance with stored computer instructions includes analyzing for more than one type of investigative lead and in which and in which writing at least a portion of the data into one or more analysis output files includes writing different types of investigative leads to different ones of the analysis output files.

5. A computer readable media including instructions for executing the steps of claim 1.

6. A computer readable media including instructions for executing the steps of claim 2.

7. A method of forensic data analysis, comprising:
a. reading a contiguous bit stream of data from an original target storage device into a temporary storage memory, the bit stream including bits from ambient data and from user files;
b. analyzing the data in the temporary memory storage to determine whether it meets one or more specified investigative criteria;
c. if the data in temporary memory storage met the specified criteria, writing the data that met the criteria into an output file; and
d. writing the bit stream of data to a back-up file.

8. The method of claim 7 further comprising repeating steps a through c until the original target storage device is analyzed.

9. The method of claim 7 in which writing the bit stream to a back-up file includes deriving a verification value from some of the bit in the bit stream.

10. The method of claim 9 in which the verification value is a cyclical redundancy check value.

11. The method of claim 7 in which analyzing the data includes detecting proper names, URLs, or e-mail addresses.

12. The method of claim 7 in which analyzing the data includes detecting arrangement of words corresponding to proper grammatical English sentences.

13. A computer readable media including instructions for executing the steps of claim 7.

14. A method of forensic data analysis, comprising:
reading contiguous bits of data from an original target storage device;
analyzing the data to determine whether it meets one or more specified investigative criteria;
if the data is insufficient to determine whether it meets the one or more investigative criteria, reading additional bits of data until the analysis can determine whether the data meets the specified investigative criteria; and
if the data meets the specified investigative criteria, writing the data into an output file.

15. The method of claim 14 in which analyzing the data includes performing multiple forensic analyses simultaneously.

16. The method of claim 15 in which performing multiple forensic analyses simultaneously includes performing multiple forensic analyses on multiple processors or using multiple threads of a processor.

17. The method of claim 14 in which reading contiguous bits of data from an original target storage device includes reading a byte of data.

18. The method of claim 14 in which reading contiguous bits of data from an original target storage device includes reading a word of data.

19. The method of claim 14 further comprising writing the data to a bit stream backup file whether or not the data meets the investigative criteria.

20. A method of forensic data analysis, comprising:
reading contiguous bits of data from an original target storage device;
performing multiple analyses simultaneously on the data, each analysis determining whether the data meets a specified investigative criterion, each analyses being preformed by a separate processor or using a separate thread of a processor; and
if any of the analyses determine the data meets the corresponding specified criterion, writing the data meeting the criterion into an analysis output file.
